(19) United States
(12) Patent Application Publication
(10) Pub. No.: US 2022/0126466 A1
(43) Pub. Date: Apr. 28, 2022

(54) HAIRDRESSING SCISSORS

(71) Applicant: Adachi Industry Co., Ltd., Gifu (JP)

(72) Inventor: Hidemi Adachi, Gifu (JP)

(21) Appl. No.: 17/451,362

(22) Filed: Oct. 19, 2021

(30) Foreign Application Priority Data
Oct. 26, 2020 (JP) 2020-178677

(51) Int. Cl. B26B 13/06; B26B 13/28

(52) U.S. Cl. CPC B26B 13/06; B26B 13/28

(57) ABSTRACT

Provided is a pair of hairdressing scissors with improved sharpness. The hairdressing scissors include a first scissor member, a second scissor member, and a connecting mechanism including a connecting member. The second scissor member is provided with a long hole relative to which the connecting member moves. Inner hollows of blade body parts are displaced toward the back side at proximal sides of the blade bodies, and curve in parallel with edge lines toward the tips of the blade bodies. Inner hollows of the intermediate parts are provided to pass through the center in the width direction of the intermediate parts. Of the inner hollows of the intermediate parts, contact points are provided at a portion between the inner hollow and the connecting member and at a portion more toward a shank part side relative to the connecting member.

### TECHNICAL FIELD

The present invention relates to hairdressing scissors.

### BACKGROUND ART

In the conventional art, various contrivances have been made to improve the sharpness of scissors. For example, Patent Document 1 discloses sliding scissors wherein one member of the scissors is provided with threaded pins at two locations, the portions contacting the blade being made flat surfaces, the other member of the scissors is provided with long holes at locations corresponding to the pins, and a cutting edge is mounted to the blade.

### RELATED ART DOCUMENTS

### Patent Documents

[Patent Document 1] Japanese Unexamined Patent Application Publication No. 1991-9782

### SUMMARY OF THE INVENTION

### Problem to be Solved by the Invention

The present invention has an object of providing hairdressing scissors with improved sharpness.

### Means for Solving the Problem

The present invention has the following features.

(Item 1)

Hairdressing scissors including:

a pair of scissor members having a blade body part, an intermediate part, and a shank part, the blade body part and the intermediate part extending in an approximately straight line; and

a connecting mechanism including a connecting member that connects the pair of scissor members at the intermediate parts,

wherein one of the pair of scissor members is provided with a long hole into which the connecting member is inserted and in relation to which the connecting member moves as the hairdressing scissors open or close, the long hole being longer in a longitudinal direction of the intermediate part, and

an inner hollow in the shape of a concave surface is provided from a position of the intermediate part of each scissor member more toward the blade body part side relative to the connecting member, across the inner surface of the blade body part, the inner hollow of the intermediate part being provided to pass through the center in the width direction of the intermediate part, the inner hollow of the blade body part being provided to be displaced toward a back side at a proximal end of the blade body part and to curve in parallel with an edge line toward a tip of the blade body part, and, out of the inner surface of the intermediate part, a contact point is provided at a portion between the inner hollow and the connecting member and at a portion more toward the shank part side relative to the connecting member.

(Item 2)

Hairdressing scissors including:

a pair of scissor members having a blade body part, an intermediate part, and a shank part, the blade body part and the intermediate part extending in an approximately straight line; and

a connecting mechanism including a connecting member that connects the pair of scissor member at the intermediate parts,

wherein one of the pair of scissor members is provided with a long hole into which the connecting member is inserted and in relation to which the connecting member moves as the hairdressing scissors open or close, the long hole being longer in a longitudinal direction of the intermediate part, and

an inner hollow in the shape of a concave surface is provided from a position of the intermediate part of each scissor member more toward the shank part side relative to the connecting member, across the inner surface of the blade body part, the inner hollow of the intermediate part being provided to pass through the center in the width direction of the intermediate part, the inner hollow of the blade body part being provided to be displaced toward a back side at a proximal end of the blade body part and to curve in parallel with an edge line toward a tip of the blade body part, and, out of the inner surface of the intermediate part, a contact point is provided at a portion more toward the shank part side relative to the inner hollow.

(Item 3)

The hairdressing scissors according to Item 1 or 2, wherein:

an outer surface of the scissor member provided with the long hole is provided with an elongate recess extending in the same direction as the long hole,

the long hole has a smaller width than the recess, and penetrates a bottom of the recess,

a surface of the bottom of the recess curves outwardly with approximately the same curvature as the curve of the inner surface of the scissor member to which the long hole is provided, and

part of the connecting member is arranged on the surface of the bottom of the recess and moves relative to the long hole along the surface of the bottom of the recess as the hairdressing scissors open or close.

The hairdressing scissors may be basic hairdressing scissors or thinning scissors.

A “contact point” as used herein refers to the portion of each scissor member that is in contact with the other scissor member when the hairdressing scissors are opened or closed. When cutting the object (hair) to be cut (that is to say, when the hairdressing scissors are closed), the contact points are in contact with each other, allowing the pair of blade body parts to move in a sliding manner without separating from each other. This makes it possible to transfer power from the blade body parts to the object to be cut, enabling cutting of the object to be cut.

### Effects of the Invention

The present invention is able to provide hairdressing scissors with improved sharpness.

### BRIEF DESCRIPTION OF THE DRAWINGS

FIG. 1 to FIG. 6 relate to hairdressing scissors according to a first embodiment of the present invention, and FIG. 7 and FIG. 8 relate to hairdressing scissors according to a second embodiment of the present invention.

FIG. 1 is a plan view of the hairdressing scissors in a closed state;

FIG. 2 is a plan view of the hairdressing scissors in an open state;

FIG. 3 is an exploded perspective view of the hairdressing scissors;

FIG. 4A is an end view taken along line IVa-IVa in FIG. 1, and FIG. 4B is a cross-sectional view taken along line IVb-IVb in FIG. 1;

FIG. 5A is a plan view showing an inner surface of a first scissor member, and FIG. 5B is a plan view showing an inner surface of a second scissor member;

FIG. 6 is an enlarged view of portion VI in FIG. 4B;

FIG. 7A is a plan view showing an inner surface of a first scissor member, and FIG. 7B is a plan view showing an inner surface of a second scissor member; and

FIG. 8 is a cross-sectional view of the hairdressing scissors in a closed state.

### EMBODIMENTS FOR CARRYING OUT THE INVENTION

### A. First Embodiment

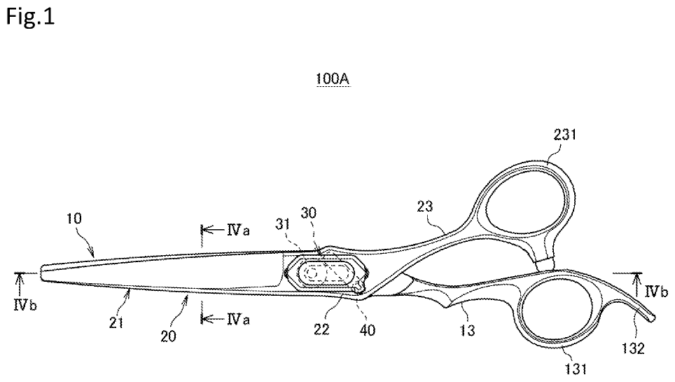

Hairdressing scissors 100A according to a first embodiment of the present invention are described with reference to FIG. 1 to FIG. 6.

### 1-1. Construction of the Hairdressing Scissors

As shown in FIG. 1 to FIG. 3, the hairdressing scissors 100A include a first scissor member 10, a second scissor member 20, and a connecting mechanism 30. The first scissor member 10 and the second scissor member 20 are connected by the connecting mechanism 30. Below, regarding each of the first scissor member 10 and the second scissor member 20, the surface facing the other scissor member 10, 20 is referred to as the “inner surface”. In addition, regarding each of the first scissor member 10 and the second scissor member 20, the surface on the opposite side of the inner surface is referred to as the “outer surface”.

As shown in FIG. 1 to FIG. 3, the first scissor member 10 includes a blade body part 11, an intermediate part 12, and a shank part 13. The blade body part 11 has an edge 11a and a back 11b,the edge 11a cooperating with an edge 21a of a blade body part 21 of the second scissor member 20 described below to cut an object to be cut (hair). The intermediate part 12 is a portion located between the blade body part 11 and the shank part 13. The blade body part 11 and the intermediate part 12 extend in an approximately straight line. The shank part 13 is provided with a ring part 131 into which a user can insert his or her ring finger, and a little finger brace 132. In the present embodiment, the first scissor member 10 is the still blade.

As shown in FIG. 1 to FIG. 3, the second scissor member 20 includes a blade body part 21, an intermediate part 22, and a shank part 23. The blade body part 21 has an edge 21a and a back 21b, the edge 21a cooperating with the edge 11a of the blade body part 11 of the first scissor member 10 to cut the object to be cut. The intermediate part 22 is a portion located between the blade body part 21 and the shank part 23. The blade body part 21 and the intermediate part 22 extend in an approximately straight line. The shank part 23 is provided with a ring part 231 into which a user can insert his or her thumb. In the present embodiment, the second scissor member 20 is the moving blade.

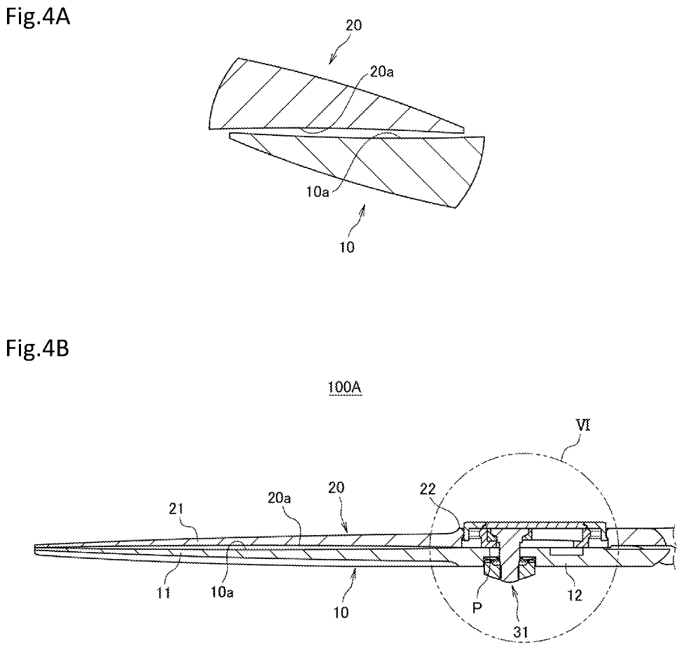

As shown in FIG. 4A and FIG. 4B, an inner surface 10a of the first scissor member 10 and an inner surface 20a of the second scissor member 20 have inner hollows (also known as “hollow ground”) in the form of concave surfaces. These inner hollows may be formed, for example, by polishing the inner surfaces 10a, 20a with a polishing device. In addition, as shown in FIG. 4B, the inner surface 10a of the first scissor member 10 and the inner surface 20a of the second scissor member 20 are curved away from the other scissor member with approximately the same curvature, so that there exists a gap between the first scissor member 10 and the second scissor member 20.

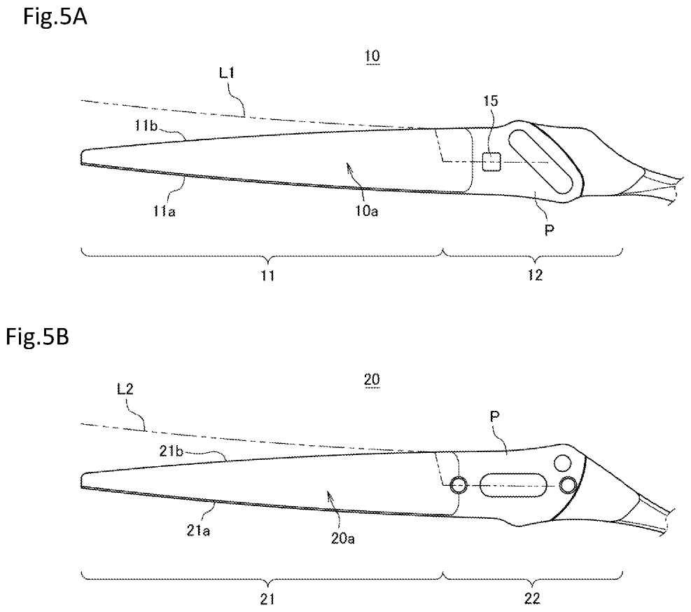

As shown in FIG. 5A, the inner hollow of the first scissor member 10 is provided from a position of the intermediate part 12 more toward the blade body part 11 side relative to a connecting member 31 described later (through hole 15 described later), across the inner surface of the blade body part 11. In FIG. 5A, the deepest part (bottom) of the concave inner hollow of the first scissor member 10 is shown by line L1. The inner hollow in the intermediate part 12 is provided so as to pass through the center in the width direction of the intermediate part 12, and the deepest part of the concave surface of the inner hollow passes through the center in the width direction of the intermediate part 12. The inner hollow in the blade body part 11 is displaced toward the back 11b side at the proximal side of the blade body part 11 (that is to say, the side closer to the intermediate part 12) and passes nearby the back 11b, and curves in parallel with the edge line of the edge 11a toward the tip of the blade body part 11. The line L1 showing the deepest part trails off from the blade body part 11 toward the tip side of the blade body part 11. In other words, at the tip side of the blade body part 11, the concave surface of the inner hollow does not reach the bottom, such that the inner hollow at the tip side of the blade body part 11 has a curved shape toward the back 11b.

As shown in FIG. 5B, the inner hollow of the second scissor member 20 is provided from a position of the intermediate part 22 more toward the blade body part 21 side relative to the connecting member 31 described later, across the inner surface of the blade body part 21. In FIG. 5B, the deepest part (bottom) of the concave inner hollow of the first scissor member 20 is shown by line L2. The inner hollow in the intermediate part 22 is provided so as to pass through the center in the width direction of the intermediate part 22, and the deepest part of the concave surface of the inner hollow passes through the center in the width direction of the intermediate part 22. The inner hollow in the blade body part 21 is displaced toward the back 21b side at the proximal side of the blade body part 21 (that is to say, the side closer to the intermediate part 22) and passes nearby the back 21b, and curves in parallel with the edge line of the edge 21a toward the tip of the blade body part 21. The line L2 showing the deepest part trails off from the blade body part 21 toward the tip side of the blade body part 21. In other words, at the tip side of the blade body part 21, the concave surface of the inner hollow does not reach the bottom, such that the inner hollow at the tip side of the blade body part 21 has a curved shape toward the back 21b.

As shown in FIG. 4 and FIG. 5, the portion of the inner surface of the intermediate part 12 of the first scissor member 10 that is on the shank part 13 side relative to the inner hollow (that is to say, the portion of the inner surface of the intermediate part 12 that is between the inner hollow and the connecting member 31, and the portion on the shank part 13 side relative to the connecting member 31) and the portion of the inner surface of the intermediate part 22 of the second scissor member 20 that is on the shank part 23 side relative to the inner hollow (that is to say, the portion of the inner surface of the intermediate part 22 that is between the inner hollow and the connecting member 31, and the portion on the shank part 23 side relative to the connecting member 31) contact each other when the hairdressing scissors 100A are opened or closed, functioning as a contact point P.

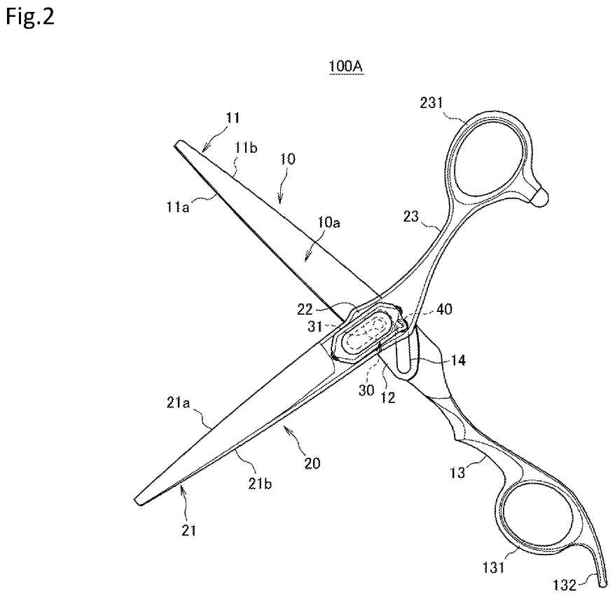

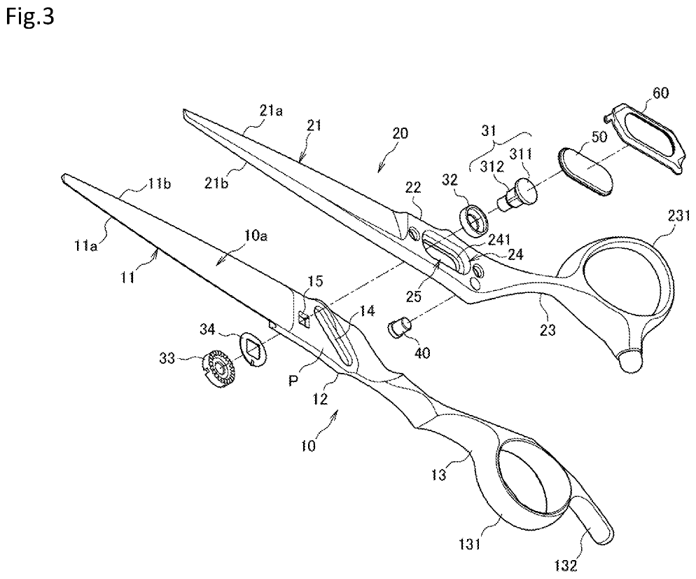

As shown in FIG. 2 and FIG. 3, the inner surface of the intermediate part 12 of the first scissor member 10 is provided with a guide groove 14. The guide groove 14 is inclined relative to the longitudinal direction of the intermediate part 12. In addition, the intermediate part 12 is provided with a through hole 15 at a position on the blade body part 11 side relative to the guide groove 14. The connecting member 31 and a shaft 312 described later are inserted into this through hole 15.

As shown in FIG. 2 and FIG. 3, the intermediate part 22 of the second scissor member 20 is provided with a guide protrusion 40 that protrudes from the inner surface of the intermediate part 22. The guide protrusion 40 is inserted into the guide groove 14. In the present embodiment, the guide protrusion 40 is a guide pin mounted to the intermediate part 22.

As shown in FIG. 3, the outer surface of the intermediate part 22 of the second scissor member 20 is provided with an elongate recess 24 that extends in the longitudinal direction of the intermediate part 22. The bottom 241 of the recess 24 is provided with a long hole 25 that penetrates the bottom 241. The long hole 25 extends in the same direction as the recess 24, and has a shorter length and smaller width than the recess 24.

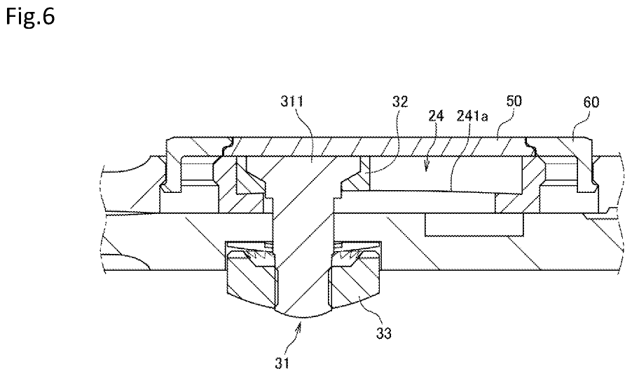

As shown in FIG. 6, the surface 241a of the bottom 241 of the recess 24 curves convexly outwardly with approximately the same curvature as the curved outer surface 20a of the second scissor member 20.

As shown in FIG. 3, the connecting mechanism 30 is composed of the connecting member 31, a collar 32, a nut 33, and a washer 34.

The connecting member 31 is, for example, a pin or a screw, and includes a round head 311 and a shaft 312 with a smaller diameter than the head 311. The collar 32 is placed on the head 311 so that the outer circumferential surface and bottom surface of the head 311 are covered by the collar 32. The collar 32 is preferably made of a material with little frictional resistance relative to the second scissor member 20, and is made of, for example, resin. The diameters of the head 311 and the collar 32 are smaller than the width of the recess 24 and larger than the width of the long hole 25. The diameter of the shaft 312 is smaller than the width of the long hole 25, and the shaft 312 passes through the long hole 25 and is inserted into the through hole 15, the washer 34, and the nut 33. The nut 33 and the washer 34 are arranged on the outer surface side of the intermediate part 12 of the first scissor member 10, and by tightening the nut 33, the connecting member 31 can be fastened to the first scissor member 10, and the first scissor member 10 and second scissor member 20 can be connected to each other.

As shown in FIG. 6, when the nut 33 is tightened, the head 311 and the collar 32 of the connecting member 31 are arranged inside the recess 24. The bottom surface of the collar 32 is in contact with the surface 241a of the bottom 241 of the recess 24. In addition, the outer circumferential surface of the collar 32 is in contact with the side surface of the recess 24.

As shown in FIG. 3 and FIG. 6, a cover 50 covering the recess 24 is arranged on the outer surface of the intermediate part 22 of the second scissor member 20. The cover 50 is preferably made of a transparent plastic material. A cover presser 60 is placed on the cover 50, and by fastening the cover presser 60 to the intermediate part 22 of the second scissor member 20, the cover 50 is fastened to the intermediate part 22.

### 1-2. Operation of the Hairdressing Scissors

Next, an operation of the hairdressing scissors 100A is described with reference to FIG. 1 and FIG. 2.

As shown in FIG. 1, in a state of maximum closure of the hairdressing scissors 100A, the guide protrusion 40 is positioned at the shank part 13-side end of the guide groove 14. In addition, the connecting member 31 is positioned at the blade body part 21-side end of the long hole 25.

As the hairdressing scissors 100A open or close, the guide protrusion 40 and the guide groove 14 move relative to each other, and the connecting member 31 and the long hole 25 move relative to each other. During the opening/closing operation of the hairdressing scissors 100A, the connecting member 31 and the collar 32 move relative to the long hole 25 while the bottom surface of the collar 32 and the surface 241a of the bottom 241 of the recess 24 are in contact with each other. In other words, during the opening/closing operation of the hairdressing scissors 100A, the head 311 of the connecting member 31 moves along the outwardly curved surface 241a. As shown in FIG. 2, in a state of maximum opening of the hairdressing scissors 100A, the guide protrusion 40 is positioned at the blade body 11-side end of the guide groove 14. In addition, the connecting member 31 is positioned at the shank part 23-side end of the long hole 25.

When the hairdressing scissors 100A are closed, the connecting member 31 moves relatively along the long hole 25, so that one of the blade body parts 11, 21 of the first scissor member 10 and the second scissor member 20 moves while sliding relative to the other blade body part 11, 21.

With these hairdressing scissors 100A, it is usually the second scissor member 20, which is the moving blade, that is moved, and therefore it is mainly the guide protrusion 40 that moves relative to the guide groove 14 (that is to say, the guide protrusion 40 moves inside the guide groove 14) and the long hole 25 that moves relative to the connecting member 31 and the collar 32.

### 1-3. Features of the Hairdressing Scissors

The hairdressing scissors 100A according to the present invention close while one of the blade body parts 11, 21 of the first scissor member 10 and the second scissor member 20 slides relative to the other blade body part 11, 21. This makes it possible to cut the object to be cut in a slicing manner, such as when cutting something using a kitchen knife, which improves sharpness.

Because the inner surface 10a of the first scissor member 10 and the inner surface 20a of the second scissor member 20 have the inner hollows as described above, opening and closing of the hairdressing scissors 100A becomes smooth. Further, because the inner surface 10a of the first scissor member 10 and the inner surface 20a of the second scissor member 20 have the inner hollows as described above, cutting power of the hairdressing scissors 100A can be improved.

Because the surface 241a of the bottom 241 of the recess 24 curves convexly outwardly with approximately the same curvature as the curve of the inner surface 20a of the second scissor member 20, the hairdressing scissors 100A can be opened or closed more smoothly.

Because placing the collar 32 on the head 311 of the connecting member 31 allows for reduced frictional resistance against the surface 241a of the bottom 241 and the side surface of the recess 24, the hairdressing scissors 100A can be opened or closed smoothly.

### B. Second Embodiment

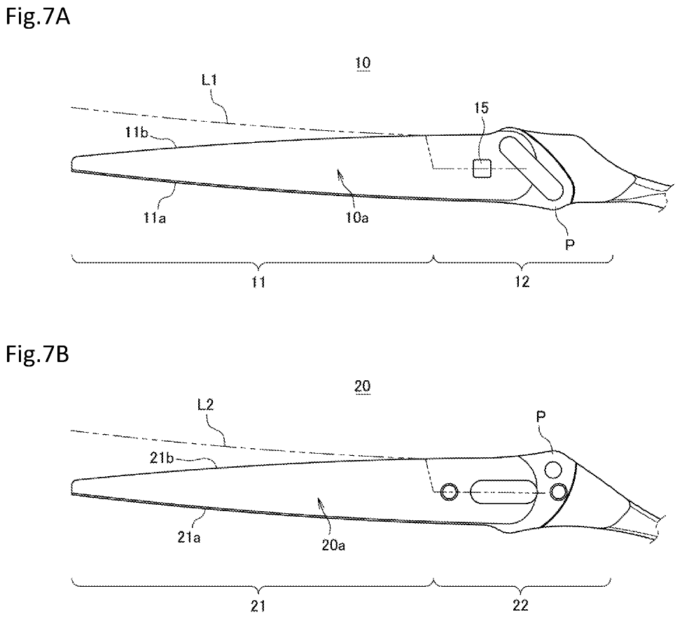

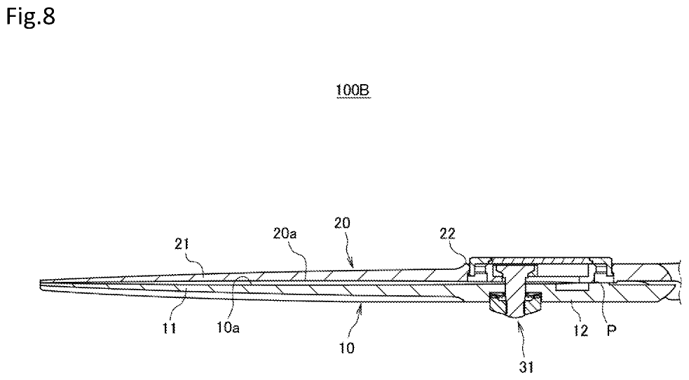

Hairdressing scissors 100B according to a second embodiment are described with reference to FIG. 7 and FIG. 8. It should be noted that the below description focuses on the differences from the above embodiment, and that components identical to or having functions identical to those of the above embodiment are given the same reference numerals as in the above embodiment, and description thereof is omitted.

The hairdressing scissors 100B according to the second embodiment differ from the first embodiment 100A in terms of the range in which the inner hollows are provided.

As shown in FIG. 7A, the inner hollow of the first scissor member 10 is provided from a position of the intermediate part 12 more toward the shank part 13 side relative to the connecting member 31 (through hole 15), across the inner surface of the blade body part 11. In addition, as shown in FIG. 7B, the inner hollow of the second scissor member 20 is provided from a position of the intermediate part 22 more toward the shank part 23 side relative to the connecting member 31, across the inner surface of the blade body part 21.

As shown in FIG. 7 and FIG. 8, the portion of the inner surface of the intermediate part 12 of the first scissor member 10 that is on the shank part 13 side relative to the inner hollow and the portion of the inner surface of the intermediate part 22 of the second scissor member 20 that is on the shank part 23 side relative to the inner hollow contact each other when the hairdressing scissors 100B are opened or closed, functioning as a contact point P.

The hairdressing scissors 100B can achieve the same effects as the hairdressing scissors 100A.

### C. Modified Example

The above embodiment indicates a preferred specific example of the present invention. The present invention is not limited to the above embodiment, but may be modified within a scope that does not depart from the gist thereof. The present invention may employ, for example, the following modified example.

(1) The recess 24, the long hole 25, and the guide protrusion 40 may be provided to the first scissor member 10, and the guide groove 14 and the through hole 15 may be provided to the second scissor member 20. In this case, the nut 33 and the washer 34 are arranged on the outer surface side of the intermediate part 22 of the second scissor member 20, and the connecting member 31 is fastened to the second scissor member 20.

### DESCRIPTION OF THE REFERENCE NUMERAL

100A Hairdressing scissors
100B Hairdressing scissors
10 First scissor member (scissor member)
10a Inner surface
11 Blade body part
12 Intermediate part
13 Shank part
20 Second scissor member (scissor member)
20a Inner surface
21 Blade body part
22 Intermediate part
23 Shank part
24 Recess
241 Bottom
241a Surface
25 Long hole
30 Connecting mechanism
31 Connecting member
P Contact point

1. Hairdressing scissors comprising:
a pair of scissor members having a blade body part, an intermediate part, and a shank part, the blade body part and the intermediate part extending in an approximately straight line; and
a connecting mechanism including a connecting member that connects the pair of scissor members at the intermediate parts,
wherein one of the pair of scissor members is provided with a long hole into which the connecting member is inserted and in relation to which the connecting member moves as the hairdressing scissors open or close, the long hole being longer in a longitudinal direction of the intermediate part, and
an inner hollow in the shape of a concave surface is provided from a position of the intermediate part of each scissor member more toward the blade body part side relative to the connecting member, across an inner surface of the blade body part, the inner hollow of the intermediate part being provided to pass through a center in a width direction of the intermediate part, the inner hollow of the blade body part being provided to be displaced toward a back side at a proximal end of the blade body part and to curve in parallel with an edge line toward a tip of the blade body part, and, out of an inner surface of the intermediate part, a contact point is provided at a portion between the inner hollow and the connecting member and at a portion more toward the shank part side relative to the connecting member.

2. Hairdressing scissors comprising:
a pair of scissor members having a blade body part, an intermediate part, and a shank part, the blade body part and the intermediate part extending in an approximately straight line; and
a connecting mechanism including a connecting member that connects the pair of scissor members at the intermediate parts,
wherein one of the pair of scissor members is provided with a long hole into which the connecting member is inserted and in relation to which the connecting member moves as the hairdressing scissors open or close, the long hole being longer in a longitudinal direction of the intermediate part, and an inner hollow in the shape of a concave surface is provided from a position of the intermediate part of each scissor member more toward the shank part side relative to the connecting member, across an inner surface of the blade body part, the inner hollow of the intermediate part being provided to pass through a center in a width direction of the intermediate part, the inner hollow of the blade body part being provided to be displaced toward a back side at a proximal end of the blade body part and to curve in parallel with an edge line toward a tip of the blade body part, and, out of an inner surface of the intermediate part, a contact point is provided at a portion more toward the shank part side relative to the inner hollow.

3. The hairdressing scissors according to claim 1, wherein:
an outer surface of the scissor member provided with the long hole is provided with an elongate recess extending in the same direction as the long hole,
the long hole has a smaller width than the recess, and penetrates a bottom of the recess,
a surface of the bottom of the recess curves outwardly with approximately the same curvature as the curve of the inner surface of the scissor member to which the long hole is provided, and
part of the connecting member is arranged on the surface of the bottom of the recess and moves relative to the long hole along the surface of the bottom of the recess as the hairdressing scissors open or close.

4. The hairdressing scissors according to claim 2, wherein:
an outer surface of the scissor member provided with the long hole is provided with an elongate recess extending in the same direction as the long hole,
the long hole has a smaller width than the recess, and penetrates a bottom of the recess,
a surface of the bottom of the recess curves outwardly with approximately the same curvature as the curve of the inner surface of the scissor member to which the long hole is provided, and
part of the connecting member is arranged on the surface of the bottom of the recess and moves relative to the long hole along the surface of the bottom of the recess as the hairdressing scissors open or close.
